(19) United States
(12) Patent Application Publication
(10) Pub. No.: US 2018/0364695 A1
(43) Pub. Date: Dec. 20, 2018

(54) UNMANNED AERIAL VEHICLE, POWER MANAGEMENT SYSTEM THEREOF, AND POWER MANAGEMENT METHOD THEREFOR

(71) Applicant: AUTEL EUROPE GMBH, Langen (DE)

(72) Inventors: Nithin PONNARASSERI, Langen (DE); Marc SCHWARZBACH, Langen (DE)

(21) Appl. No.: 15/794,627

(22) Filed: Oct. 26, 2017

(30) Foreign Application Priority Data
Jun. 16, 2017 (EP) 17176344.4

(51) Int. Cl. G05D 1/00; B64C 39/02

(52) U.S. Cl. CPC G05D 1/0005; B64C 39/024; B64C 2201/146; B64C 2201/06; B64C 2201/042

(57) ABSTRACT

The present invention relates to an unmanned aerial vehicle (UAV), a power management system thereof, and a power management method therefor. The power management system includes a first power unit, a second power unit, and a power path controller. The first power unit and the second power unit are connected to a payload by using a switch unit, and the switch unit is electrically connected to the power path controller. The power path controller monitors flight mode information from a microcontroller unit of the UAV, determines a power module supplying power to the load according to the flight mode information, and switches on the first power unit or the second power unit to supply power to the load by controlling the switch unit. The power management system can increase endurance of the UAV, and can implement seamless and efficient switching between the different power modules.

### CROSS REFERENCE TO RELATED APPLICATION

This application claims priority to Europe Patent Application No. 17176344.4, filed on Jun. 16, 2017, the disclosure of which is incorporated herein reference in its entirety.

### TECHNICAL FIELD

The present invention relates to the technical filed of an unmanned aerial vehicle, and specifically to an unmanned aerial vehicle (UAV), a power management system thereof, and a power management method therefor.

### BACKGROUND

UAVs are mainly used in the fields such as aerial photography, agricultural plant protection, and surveying and mapping. At present, with the development of wireless network transmission technologies, application fields of the UAVs are greatly expanded by using UAVs having high image processing capacities and high transmission capacities. In addition, as functions of the UAV are increased, energy consumptions of a motor, a gimbal, a camera, and a flight controller of the UAV become higher. An endurance of a related UAV is usually between twenty and forty minutes. How to provide power to support the endurance of the UAV is an issue to be urgently resolved currently.

A UAV cannot use an external power supply during flight, and the UAV is powered by a lithium battery disposed inside an airframe of the UAV. For related UAV, a single high-power lithium battery is usually used as a power supply to supply power to the UAV, and the endurance is usually increased by adding a power supply to the UAV. The UAV switches between the two power supplies according to detected voltages of the two power supplies. Such a manner of passively switching the power supplies according to the detected voltages results in the shortcoming of low efficiency. In addition, only a standby power supply is simply provided, rather than providing power management according to an entire control and flight status of the UAV.

Therefore, a power supply mode of a UAV in the prior art is to be further improved.

### SUMMARY

A technical problem to be resolved in the present invention is to provide a solution for energy consumption distribution of power modules of a UAV, a power management system and a power management method that can greatly increase an endurance and implement efficient and seamless switching between different power modules, and a UAV using the power management system and the power management method.

To resolve the technical problem, the present invention provides the following solutions:

The present invention provides a power management system, including:

a first power unit, configured to supply power to a payload in a high-power flight mode;

a second power unit, configured to supply power to the payload in a low-power flight mode;

a power path controller, configured to select the first power unit or the second power unit to supply power to the payload according to a flight mode of a UAV;

a switch unit, electrically connected between the first power unit and the power path controller, and electrically connected between the second power unit and the power path controller, where

the power path controller controls, the switch unit to switch between the first power unit and the second power unit according to the flight mode of the UAV, so that the first power unit or the second power unit is switched on to supply power to the payload.

In an embodiment of the present invention, the power management system further includes a monitoring circuit that is configured to monitor a current or voltage of the payload and feed back the current or the voltage of the payload to the power path controller, one end of the monitoring circuit is electrically connected to an output end of the switch unit, and the other end is electrically connected to the payload.

In an embodiment of the present invention, the monitoring circuit is a current monitoring circuit, including a current detection resistor, a current sensor, and a current monitor that are electrically connected in sequence, one end of the current detection resistor is electrically connected to the output end of the switch unit, the other end is electrically connected to an input end of the payload, and an output end of the current monitor is electrically connected to the power path controller.

In an embodiment of the present invention, the power management system further includes a selector that is configured to monitor the flight mode of the UAV and receive the current information of the payload fed back by the current monitor, an input end of the selector is electrically connected to the current monitor, and an output end of the selector is electrically connected to the power path selector.

In an embodiment of the present invention, the power management system further includes:

a support unit, electrically connected to the power path controller, and configured to: when no flight mode information or no current information of the payload is input to the selector, supply power to the payload and enable the UAV to operate in a low-power mode.

In an embodiment of the present invention, the switch unit includes a first switch that is electrically connected between the first power unit and the power path controller and a second switch that is electrically connected between the second power unit and the power path controller.

In an embodiment of the present invention, both the first switch and the second switch are P-channel metal-oxide semiconductor field-effect transistors (P-channel MOSFETs), and gates of the first switch and the second switch are electrically connected to the power path controller.

In an embodiment of the present invention, the first power unit is a high power battery, and the second power unit is a high density battery.

An UAV is provided, including an airframe, a microcontroller unit disposed inside the airframe, and a gimbal connected to the airframe, the UAV further includes the foregoing power management system.

A power management method for a UAV is provided, the UAV includes a first power unit and a second power unit, the first power unit and the second power unit supply power to the UAV by using a switch unit, and the method includes:

obtaining a fight mode information of the UAV; and

switching the switch unit to switch on the first power unit to supply power to the UAV when the flight mode is a high power mode, or switching the switch unit to switch on the second power unit to supply power to the UAV when a flight mode is a low power mode.

In an embodiment of the present invention, when no flight mode information is obtained, switch the switch unit to switch on the second power unit to supply power to the UAV to the UAV and enable the UAV to operate in the low power mode.

In an embodiment of the present invention, the method further includes:

monitoring a payload current;

determining whether a payload current value is greater than a preset value; and

switching the switch unit to switch on the first power unit to supply power to the UAV when the load current value is a greater than the preset value, or switching the switch unit to switch on the second power unit to supply power to the UAV when the payload current value is less than the preset value.

In an embodiment of the present invention, wherein when no current information of the payload is monitored, switch the switch unit to switch on the second power unit to supply power to the UAV to the UAV and enable the UAV to operate the low power mode.

Beneficial effects of the present invention are that: two power modules having different power characteristics are provided, and a power path controller selects the power module suitable for the current flight status to supply power to the UAV according to the flight mode information and energy consumption information of a payload that are fed back by a controller unit of the UAV, thereby increasing the endurance and power usage efficiency of the UAV, and implementing efficient and seamless switching between the two power modules, and therefore achieving smooth flight while increasing the endurance.

### BRIEF DESCRIPTION OF THE DRAWINGS

One or more embodiments are described as examples with reference to the figures in the accompanying drawings, and the examples do not constitute a limitation to the embodiments. Elements having same reference numerals in the accompanying drawings represent similar elements. The figures in the accompanying drawings are not necessarily drawn to scale unless otherwise noted.

FIG. 1 is an illustrative diagram of a UAV according to an embodiment of the present invention;

FIG. 2 is an equivalent circuit diagram of a power management system according to an embodiment of the present invention;

FIG. 3 is a schematic diagram of the power management system of the UAV in a first switching mode according to an embodiment of the present invention; and

FIG. 4 is a flowchart of a power management method according to an embodiment of the present invention.

### DETAILED DESCRIPTION

To make the objectives, technical solutions, and advantages of the present invention clearer and more comprehensible, the following further describes the present invention in detail with reference to the accompanying drawings and embodiments. It should be understood that, the specific embodiments described herein are merely for illustration of the present invention, and are not intended to limit the present invention.

Embodiments of the present invention provide a power management system, a power management method, and a UAV, to increase an endurance.

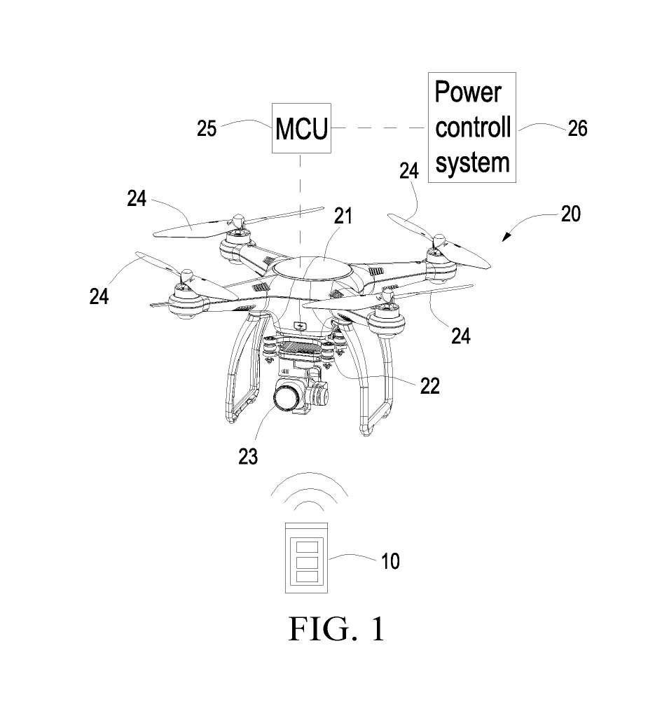

Referring to FIG. 1, the UAV 20 includes an airframe 21, a microcontroller unit (MCU) 25 disposed inside the airframe 21, a gimbal 22 connected to the airframe 21, a camera 23 carried on the gimbal 22, and a power management system 26 disposed inside the airframe 21. A user sends an operation instruction and a control instruction by a remote control center 10 wirelessly connecting to the UAV 20. The UAV 20 in this embodiment may be a multi-rotor UAV, or may be a helicopter, a hex-rotor UAV, or the like. The UAV 20 is driven flight by a lift force generated by the rotation of a propeller 24 driven by a motor disposed on the airframe 21.

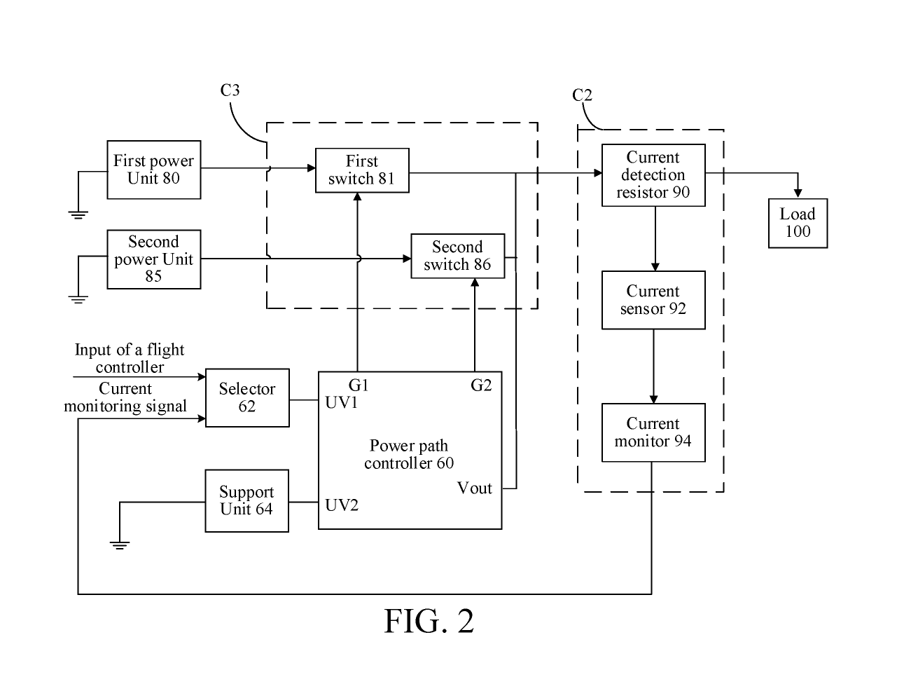

As shown in FIG. 2, the power management system 26 includes a selector 62 that is configured to obtain flight mode information from a microcontroller unit 25, a power path controller 60 electrically connected to the selector 62, and a first power unit 80 and a second power unit 85 having different power characteristics. The first power unit 80 and the second power unit 85 are electrically connected to the power path controller 60 by using a switch unit C3. The selector 62 sends the flight mode information of the UAV to the power path controller 60, and the power path controller 60 selects the first power unit 80 or the second power unit 85 to supply power to the UAV according to the received flight mode information.

The power management system 26 may further include a monitoring circuit C2 and one end of the monitoring circuit C2 is electrically connected to the switch unit C3 and the other end of the monitoring circuit C2 is electrically connected to a payload 100. The monitoring circuit C2 feeds back a detected current flowing into the payload 100 or a detected voltage across the payload 100 to the power path controller 60, and the power path controller 60 controls the switch unit C3 to switch on the first power unit 80 or the second power unit 85 to supply power to the UAV according to the payload current value or the payload voltage value fed back by the monitoring circuit C2. Specifically, in an embodiment of the present invention, the monitoring circuit C2 detects the payload current, and the monitoring circuit C2 includes a current detection resistor 90, a current sensor 92, and a current monitor 94 that are electrically connected in sequence. One end of the current detection resistor 90 is electrically connected to an output end of the switch unit C3, and the other end is electrically connected to an input end of the payload 100. The current monitor 94 feeds back the detected payload current to the power path controller 60.

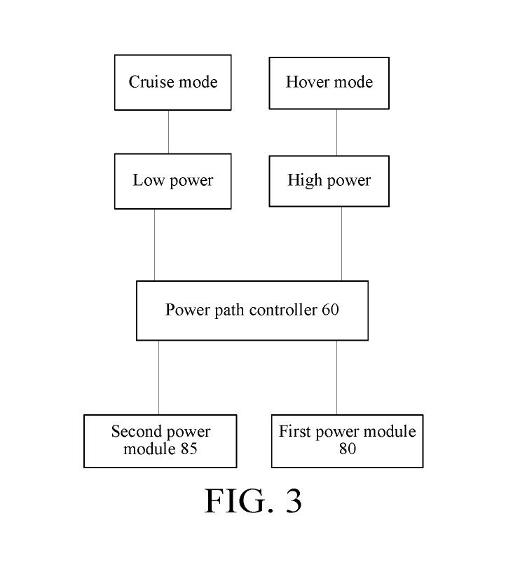

Therefore, the power management system 26 has a first switching mode in which switching is performed between the power modules according to the flight mode (a hover mode or a cruise mode) of the UAV and a second switching mode in which switching is performed between the power modules based on the payload current (or the load voltage) fed back by the monitoring circuit C2. In the first switching mode, the power path controller 60 controls, according to the flight mode of the UAV, the switch unit C3 to perform switching between the first power unit 80 and the second power unit 85, to select a power module suitable for the current flight mode to supply power to the UAV. The first power unit 80 is a high-power battery power module, and may transfer high-energy power to the UAV. The second power unit 85 is a low-power battery power module such as a high-density battery power module, has a low operating current, and may provide a low power supply. For example, as shown in FIG. 3, when the flight mode of the UAV is a high-power flight mode (for example, the hover mode), the power path controller 60 selects, according to the flight mode information, the first power unit 80 to supply power to the UAV. When the flight mode selected by the microcontroller unit 25 is a low-power flight mode (for example, the cruise mode), the power path controller 60 selects, according to the flight mode information, the second power unit 85 to supply power to the UAV. However, in the second switching mode, the monitoring circuit C2 collects a current flowing through the payload 100. When the current value is greater than a preset value which indicates that the UAV needs high-energy power, the power path controller 60 selects the first power unit 80 to supply power to the UAV. When the current value is less than the preset value which indicates that the UAV needs only low power supply, the power path controller 60 selects the second power unit 85 to supply power to the UAV.

Specifically, the first power unit 80 is a high power battery, and the second power unit 85 is a high density battery. In the hover mode, to enable the UAV to steadily take off and land, the UAV needs high-energy power transferred by the high power battery. In the cruise mode, the UAV only needs to maintain smooth flight, and limited energy may be wasted if the high power battery is continued being used to supply power. However, the high density battery has a low current, and can provide a low power supply which is therefore suite for the cruise mode.

In an optional embodiment, the power management system 26 may further include a support unit 64 that is electrically connected to the power path controller 60. When the selector 62 neither receives any flight mode information from the microcontroller unit 25, nor receives feedback of the monitoring circuit C2, the support unit 64 supplies power to the UAV to make the UAV operate in a low-power mode.

In an embodiment of the present invention, the support unit 64 supplies a constant voltage of 5 V, and continuously inputs a high level signal to the power path controller 60. The selector 62 is an OR selector.

The power management system provided in this embodiment meets both a high power requirement during UAV landing and taking off and a low power requirement during cruising flight without energy waste. An endurance of the UAV can be effectively increased by using the power management system.

In this embodiment, the switch unit C3 includes a first switch 81 that is electrically connected to the first power unit 80 and the power path controller 60 and a second switch 86 that is electrically connected to the second power unit 85 and the power path controller 60, and both the first switch 81 and the second switch 86 are electrically connected to the payload 100. It may be understood that, the switch unit C3 may be a bidirectional switch that is controlled by the power path controller 60 and that may perform switching between the first power unit 80 and the second power unit 85. For example, the first switch 81 and the second switch 86 are P-channel MOSFETs. When the microcontroller unit 25 of the UAV selects the cruise mode, the power path controller 60 controls the second switch 86 to close to select the second power unit 85, that is, a low power battery such as a high density battery, to supply power to the UAV. When the microcontroller unit 25 of the UAV selects the hover mode, the power path controller 60 selects the first power unit 80, that is, a high power battery, to supply power to the UAV.

To implement steady seamless switching, an operating process of the power path controller 60 is briefly described as follows: when the first switch 81 and the second switch 86 are switched, the power path controller 60 uses a break-before-make switching manner, to prevent cross conduction between channels of the transistors and reverse conduction of the transistors.

The flight mode is determined by the microcontroller unit 25 of the UAV according to a remote control signal of a user or a navigation requirement of the UAV. In the first switching mode, the microcontroller unit 25 may obtain flight mode information, and send a signal to the power path controller 60. The power path controller 60 selects a suitable power module to supply power to the UAV. Alternatively, the power path controller 60 may select power modules to supply power to the payload in different flight modes according to a prestored power module selection policy

In the second switching mode, the power path controller 60 and the monitoring circuit C2 performs switching between the first power unit 80 and the second power unit 85 according to the current consumption of the payload 100. In an implementation of the second switching mode, the current monitor 94 compares a current value fed back by the current detection resistor 90 with a preset current value, and feeds back the comparison result to the power path controller 60. The power path controller 60 controls the first power unit 80 or the second power unit 85 to supply power to the UAV. In another implementation of the second switching mode, the current monitor 94 feeds back the detected current value to the power path controller 60. The power path controller 60 performs determination according to a locally stored determination threshold, and closes the first switch 81 or the second switch 86 to switch on the first power unit 80 or the second power unit 85 to supply power to the UAV. Switch parameters such as the preset current value in the second switching mode are determined based on a capacity of the high density battery. For example, if 20 A (A, ampere) is a maximum capacity of the high density battery, a monitoring current value of the current monitor 94 is set to 15 A. When an actual current output from the current monitor 94 to the payload 100 is greater than 15 A, the current monitor 94 inputs a high level enable signal to the power path controller 60, so that an output end Vout of the power path controller 60 is switched to a power supply path of the high power battery.

According to the UAV in this embodiment of the present invention, two power modules having different power characteristics are provided, and the power path controller 60 selects a power module suitable for a current flight mode to supply power to the UAV according to flight mode information of the microcontroller unit 25 and an energy consumption parameter of the payload, so that an endurance of the UAV may be increased by twenty-five percent to forty percent.

In this embodiment of the present invention, the power management system is applied to a UAV having two power modules. It may be understood that, the power management system may also be applied to a UAV including multiple power modules. This is determined according to a specific design requirement of the UAV. In another possible implementation, the power management system may be integrated in the microcontroller unit of the UAV.

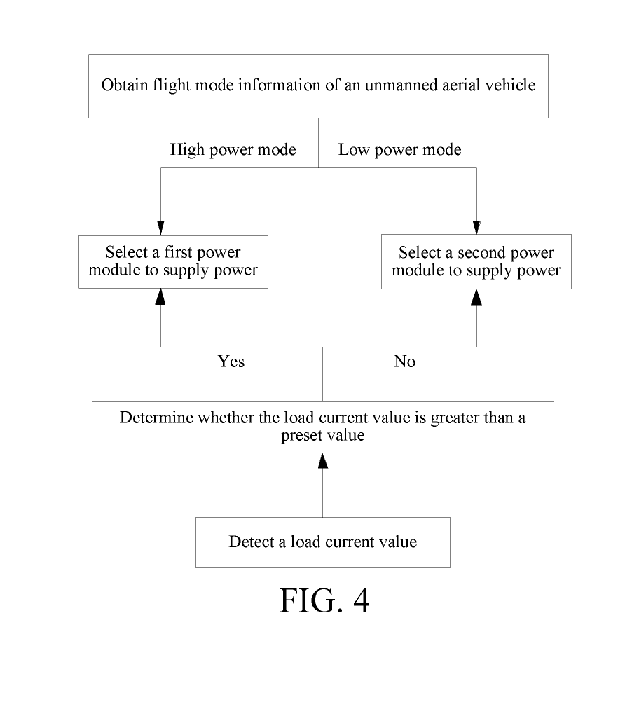

Referring to FIG. 4, the present invention further provides a power management method for a UAV. The UAV includes a first power unit and a second power unit, the first power unit and the second power unit supply power to the UAV by using a switch unit, and the method includes the following steps:

S1: Obtain flight mode information of the UAV.

S2: Switch the switch unit to switch on the first power unit to supply power to the UAV when a flight mode is a high power mode, or switch the switch unit to switch on the second power unit to supply power to the UAV when a flight mode is a low power mode.

The method may further include:

when no flight mode information is obtained, switch the switch unit to switch on the second power unit to supply power to the UAV to the UAV and enable the UAV to operate in the low power mode.

The method may further include:

monitoring a payload current;

determining whether a payload current value is greater than a preset value; and switching the switch unit to switch on the first power unit to supply power to the UAV when the payload current value is a greater than the preset value, or switching the switch unit to switch on the second power unit to supply power to the UAV when the payload current value is a less than the preset value.

The method may further include:

when no current information of the payload is monitored, switch the switch unit to switch on the second power unit to supply power to the UAV to the UAV and enable the UAV to operate the low power mode.

According to the UAV, the power management system thereof, and the power management method therefor provided in the embodiments of the present invention, two power supplies having different power characteristics are provided, to meet a high power requirement of the UAV during taking off and landing and a low power requirement during cruise flight. In addition, the power management system can select, according to a flight status parameter from a microcontroller unit and/or an energy consumption parameter of a load, a power module suitable for a current flight status to supply power to the load, thereby increasing an endurance and power usage efficiency of the UAV. Tests show that the endurance of the UAV can be increased by twenty-five percent to forty percent by using the power management system provided in the present invention.

It should be finally noted that, the foregoing embodiments are merely intended for describing the technical solutions of the present invention, rather than limiting the present invention. According to concepts of the present invention, technical features in the foregoing embodiments or different embodiments may also be combined, steps may be implemented in any sequence, and there may be many other variations of the present invention in different aspects. For simplicity, the variations are not provided in details. Although the present invention is described in detail with reference to the foregoing embodiments, persons of ordinary skill in the art should understand that they may still make modifications to the technical solutions described in the foregoing embodiments or make equivalent replacements to some technical features thereof, and the essence of corresponding technical solutions does not depart from the scope of the technical solutions in the embodiments of the present invention in spite of these modifications or replacements.

1. A power management system, comprising:
a first power unit, configured to supply power to a payload in a high-power flight mode;
a second power unit, configured to supply power to the payload in a low-power flight mode;
a power path controller, configured to select the first power unit or the second power unit to supply power to the load according to a flight mode of an unmanned aerial vehicle; and
a switch unit, electrically connected between the first power unit and the power path controller, and electrically connected between the second power unit and the power path controller, wherein
the power path controller controls the switch unit to switch between the first power unit and the second power unit according to the flight mode of the UAV, so that the first power unit or the second power unit is switched on to supply power to the payload.

2. The power management system according to claim 1, wherein the power management system further comprises a monitoring circuit that is configured to monitor a current or voltage of the payload and feed back the current or the voltage of the payload to the power path controller, one end of the monitoring circuit is electrically connected to an output end of the switch unit, and the other end is electrically connected to the payload.

3. The power management system according to claim 2, wherein the monitoring circuit is a current monitoring circuit, comprising a current detection resistor, a current sensor, and a current monitor that are electrically connected in sequence, one end of the current detection resistor is electrically connected to the output end of the switch unit, the other end is electrically connected to an input end of the payload, and an output end of the current monitor is electrically connected to the power path controller.

4. The power management system according to claim 3, wherein the power management system further comprises a selector that is configured to monitor the flight mode of the UAV and receive the current information of the payload fed back by the current monitor, an input end of the selector is electrically connected to the current monitor, and an output end of the selector is electrically connected to the power path controller.

5. The power management system according to claim 1, wherein the power management system further comprises:
a support unit, electrically connected to the power path controller, and configured to: when no flight mode information or no current information of the payload is input to the selector, supply power to the payload and enable the UAV to operate in the low-power mode.

6. The power management system according to claim 1, wherein the switch unit comprises a first switch that is electrically connected between the first power unit and the power path controller and a second switch that is electrically connected between the second power unit and the power path controller.

7. The power management system according to claim 6, wherein both the first switch and the second switch are P-channel metal-oxide semiconductor field-effect transistors, P-channel MOSFETs, and gates of the first switch and the second switch are electrically connected to the power path controller.

8. The power management system according to claim 1, wherein the first power unit is a high power battery, and the second power unit is a high density battery.

9. An unmanned aerial vehicle, UAV, comprising an airframe, a microcontroller unit disposed inside the airframe, and a gimbal connected to the airframe, wherein the UAV further comprises the power management system, the power management system, comprising:
a first power unit, configured to supply power to a payload in a high-power flight mode;
a second power unit, configured to supply power to the payload in a low-power flight mode;
a power path controller, configured to select the first power unit or the second power unit to supply power to the load according to a flight mode of an unmanned aerial vehicle; and
a switch unit, electrically connected between the first power unit and the power path controller, and electrically connected between the second power unit and the power path controller, wherein
the power path controller controls the switch unit to switch between the first power unit and the second power unit according to the flight mode of the UAV, so that the first power unit or the second power unit is switched on to supply power to the payload.

10. The power management system according to claim 9, wherein the power management system further comprises a monitoring circuit that is configured to monitor a current or voltage of the payload and feed back the current or the voltage of the payload to the power path controller, one end of the monitoring circuit is electrically connected to an output end of the switch unit, and the other end is electrically connected to the payload.

11. The power management system according to claim 10, wherein the monitoring circuit is a current monitoring circuit, comprising a current detection resistor, a current sensor, and a current monitor that are electrically connected in sequence, one end of the current detection resistor is electrically connected to the output end of the switch unit, the other end is electrically connected to an input end of the payload, and an output end of the current monitor is electrically connected to the power path controller.

12. The power management system according to claim 11, wherein the power management system further comprises a selector that is configured to monitor the flight mode of the UAV and receive the current information of the payload fed back by the current monitor, an input end of the selector is electrically connected to the current monitor, and an output end of the selector is electrically connected to the power path controller.

13. The power management system according to claim 9, wherein the power management system further comprises:
a support unit, electrically connected to the power path controller, and configured to: when no flight mode information or no current information of the payload is input to the selector, supply power to the payload and enable the UAV to operate in a low-power mode.

14. The power management system according to claim 9, wherein the switch unit comprises a first switch that is electrically connected between the first power unit and the power path controller and a second switch that is electrically connected between the second power unit and the power path controller.

15. The power management system according to claim 14, wherein both the first switch and the second switch are P-channel metal-oxide semiconductor field-effect transistors, P-channel MOSFETs, and gates of the first switch and the second switch are electrically connected to the power path controller.

16. The power management system according to claim 9, wherein the first power unit is a high power battery, and the second power unit is a high density battery.

17. A power management method for an unmanned aerial vehicle, UAV, wherein the UAV comprises a first power unit and a second power unit, the first power unit and the second power unit supply power to the UAV by using a switch unit, and the method comprises:
obtaining flight mode information of the UAV; and
switching the switch unit to switch on the first power unit to supply power to the UAV when the flight mode is a high power mode, or switching the switch unit to switch on the second power unit to supply power to the UAV when a flight mode is a low power mode.

18. The power management method of a UAV according to claim 17, wherein the method may further include when no flight mode information is obtained, switch the switch unit to switch on the second power unit to supply power to the UAV to the UAV and enable the UAV to operate in the low power mode.

19. The power management method of a UAV according to claim 17, wherein the method further comprises:
monitoring a payload current;
determining whether a payload current value is greater than a preset value; and
switching the switch unit to switch on the first power unit to supply power to the UAV when the load current value is a greater than the preset value, or switching the switch unit to switch on the second power unit to supply power to the UAV when the load current value is less than the preset value.

20. The power management method of the UAV according to claim 19, wherein the method may further include when no current information of the payload is monitored, switch the switch unit to switch on the second power unit to supply power to the UAV to the UAV and enable the UAV to operate the low power mode.
